(19) United States
(12) Patent Application Publication
(10) Pub. No.: US 2026/0366955 A1
(43) Pub. Date: Nov. 19, 2026

(54) FIBER LASER TESTING SYSTEM AND FIBER LASER TESTING METHOD

(71) Applicant: WuHan Raycus Fiber Laser Technologies Co., Ltd, Wuhan, Hubei (CN)

(72) Inventors: Ziwei WANG, Wuhan, Hubei (CN); Huixuan HU, Wuhan, Hubei (CN); Dapeng YAN, Wuhan, Hubei (CN)

(73) Assignee: WuHan Raycus Fiber Laser Technologies Co., Ltd, Wuhan, Hubei (CN)

(21) Appl. No.: 18/995,932

(22) PCT Filed: May 20, 2024
(86) PCT No.: PCT/CN2024/094231

§ 371 Date: Jan. 17, 2025

(30) Foreign Application Priority Data
Jul. 19, 2023 (CN) 202310885678.1

(51) Int. Cl. G01M 11/02; H01S 3/00; H01S 3/102

(52) U.S. Cl. CPC G01M 11/0207; H01S 3/0014; H01S 3/1026

(57) ABSTRACT

A fiber laser testing system and a fiber laser testing method are disclosed in the present application, the system includes an output fiber, a fiber fixing tooling, a cooling assembly, a power test device, a temperature test device, and a controller, the controller is configured for determining whether an aging test result of the fiber laser to be tested is qualified based on an optical power; determining whether there are mounting abnormalities among the fiber laser to be tested, the cooling assembly, and the end cap based on the first temperature and the second temperature, and outputting an abnormal result.

The present application claims the priority to Chinese Application No. 202310885678.1, filed to China National Intellectual Property Administration on Jul. 19, 2023, the content of which is incorporated herein by reference in its entirety.

### TECHNICAL FIELD

The present application relates to the field of laser testing technology, and in particular to a fiber laser testing system and a fiber laser testing method.

### BACKGROUND

Fiber lasers have characteristics of good beam quality and high conversion efficiency, and market share of the fiber lasers in a laser market is gradually increasing. In order to provide users with complete information about fiber lasers, performance testing of the fiber lasers is required during development or production stage. As the power of fiber lasers is getting higher and higher, returning light is getting larger and larger. In the process of laser testing, the influence of returning light on pump chips was not considered, which leads to damage to the fiber lasers, affects reliability of the fiber lasers, and also affects accuracy of test results of the fiber lasers.

### SUMMARY

Embodiments of the present application provide a fiber laser testing system and a fiber laser testing method to solve a problem that in an existing art, fiber lasers are damaged during a testing process and accuracy of test results is affected due to returning light.

In a first aspect, embodiments of the present application provide a fiber laser testing system, including:
an output fiber, including a fiber body and a metal housing, one end of the fiber body being connected to a fiber laser to be tested, another end of the fiber body being fused to an end cap, and the metal housing being sleeved on the end cap and the fiber body;
a fiber fixing tooling, configured for fixing the output fiber;
a cooling assembly, configured for cooling the fiber laser to be tested and the end cap;
a power detecting device, configured for detecting an optical power of a laser beam emitted from the output fiber in real time;
a temperature detecting device, configured for detecting a first temperature of the fiber laser to be tested and a second temperature of the end cap in real time; and
a controller, connected to the power detecting device and the temperature detecting device respectively, the controller being configured for:
receiving the optical power, the first temperature, and the second temperature;
during a testing period, determining whether an aging test result of the fiber laser to be tested is qualified based on the optical power, and outputting a test result; and
during the testing period, determining whether there are mounting abnormalities among the fiber laser to be tested, the cooling assembly, and the end cap based on the first temperature and the second temperature, and outputting an abnormal result.

In a second aspect, embodiments of the present application further provide a fiber laser testing method, applied to the fiber laser testing system of any of the embodiments described above, including following steps:
obtaining an optical power of a laser beam output from a fiber laser to be tested, a first temperature of the fiber laser to be tested, and a second temperature of an end cap;
during a testing period, determining whether an aging test result of the fiber laser to be tested is qualified based on the optical power, and outputting a test result; and
during the testing period, determining whether there are abnormalities in the fiber laser to be tested and the end cap based on the first temperature and the second temperature, and outputting an abnormal reason.

Beneficial effects of the present application are as follows. In the fiber laser testing system and the fiber laser testing method provided by the embodiments of the present application, a laser beam emitted from a fiber laser to be tested is injected into a power detecting device through an output fiber with an end cap, the optical power of the laser beam is detected by the power detecting device, and an aging test result of the fiber laser to be tested is determined based on the optical power. In the process of an optical power detection, the influence of returning light on the fiber laser to be tested is reduced, and the problem that the fiber laser is damaged and accuracy of test results is affected due to the returning light is solved. In addition, in the process of an aging test, the first temperature of the fiber laser to be tested and the second temperature of the end cap are detected through the temperature detecting device, so as to determine whether there is a mounting abnormality among the fiber laser to be tested, the cooling assembly, and the end cap, so that an aging test result of the fiber laser to be tested due to an abnormal mounting structure is avoided, and the accuracy of the aging test result is ensured.

### BRIEF DESCRIPTION OF THE DRAWINGS

In order that the technical solutions in the embodiments of the present application may be explained more clearly, a brief description will be given below to the accompanying drawings for use in the description of the embodiments. Obviously, the accompanying drawings in the following description are merely some of the embodiments of the present application, and other drawings can be obtained based on these drawings without involving any creative efforts to those skilled in the art.

For the sake of a complete understanding of the present application and its advantages, reference will now be made to the accompanying drawings. In the following description, same reference numerals refer to same parts.

FIG. 1 is a block diagram of a testing system provided in an embodiment of the present application.

FIG. 2 is a block diagram of a control section of a testing system provided in an embodiment of the present application.

FIG. 3 is a schematic diagram of a structure of an assembly of an output fiber and a fiber fixing tooling provided in an embodiment of the present application.

FIG. 4 is a schematic diagram of a structure of a fiber fixing tooling provided in an embodiment of the present application.

FIG. 5 is a schematic diagram of a structure of an output fiber provided in an embodiment of the present application.

FIG. 6 is a top view of a metal housing of an output fiber provided in an embodiment of the present application.

FIG. 7 is a cross-sectional view of the metal housing taken along line A-A in FIG. 6.

FIG. 8 is a flow diagram of a fiber laser testing method provided in an embodiment of the present application.

FIG. 9 is a flow diagram of a fiber laser testing method provided in an embodiment of the present application.

FIG. 10 is a flow diagram of a fiber laser testing method provided in an embodiment of the present application.

FIG. 11 is a flow diagram of a fiber laser testing method provided in an embodiment of the present application.

### REFERENCE NUMERALS IN THE DRAWINGS

100: output fiber; 110: fiber body; 120: end cap; 130: metal housing; 131: glue dispensing hole; 1311: first glue dispensing hole; 1312: second glue dispensing hole; 132: first segment; 133: second segment; 134: third segment; 135: first cavity; 136: second cavity; 137: third cavity; 200: fiber fixing tooling; 210: base body; 211: first end; 212: second end; 213: first side surface; 214: recessed area; 215: mounting hole; 220: first mounting slot; 221: first side wall; 222: second side wall; 223: third side wall; 224: first sub-slot; 225: second sub-slot; 230: second mounting slot; 240: baffle; 241: groove; 300: cooling assembly; 400: power test device; 500: temperature test device; 600: controller.

### DETAILED DESCRIPTION

The technical solutions in the embodiments of the present application will be clearly and completely described with reference to the accompanying drawings below. It will be apparent that the described embodiments are only part of the examples of the present application, and not all examples. Based on the embodiments in the present application, all other embodiments obtained by a person skilled in the art without involving any creative effort are within the scope of the present application.

Embodiments of the present application provide a fiber laser testing system to solve a problem that in an existing art, fiber lasers are damaged during a test process and accuracy of test results is affected due to returning light. The following are illustrated in conjunction with the accompanying drawings.

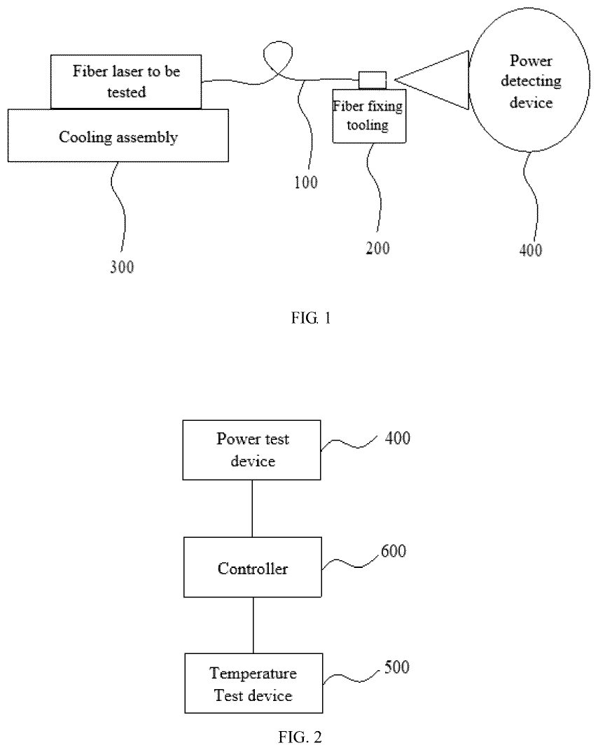

Referring to FIG. 1 and FIG. 2, FIG. 1 is a block diagram of a testing system provided in an embodiment of the present application, and FIG. 2 is a block diagram of a control section of a testing system provided in an embodiment of the present application.

Embodiments of the present application provide a fiber laser testing system applied to high-power or ultra-high-power fiber lasers to be tested. A power of the high-power or ultra-high-power fiber lasers to be tested can be of a kW-class or more. The fiber laser testing system includes an output fiber 100, a fiber fixing tooling 200, a cooling assembly 300, a power test device 400, a temperature test device 500, and a controller 600.

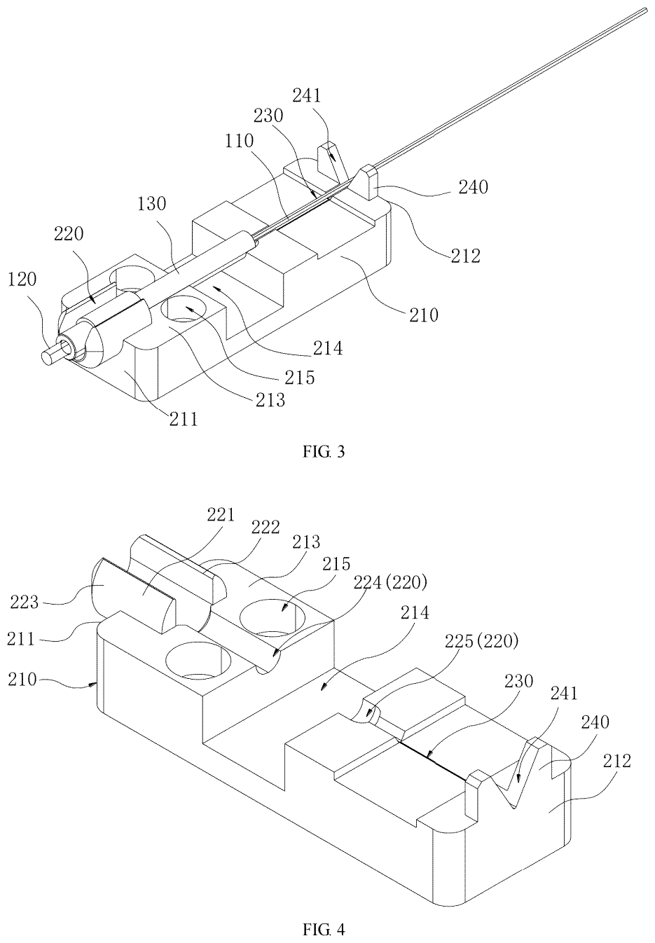

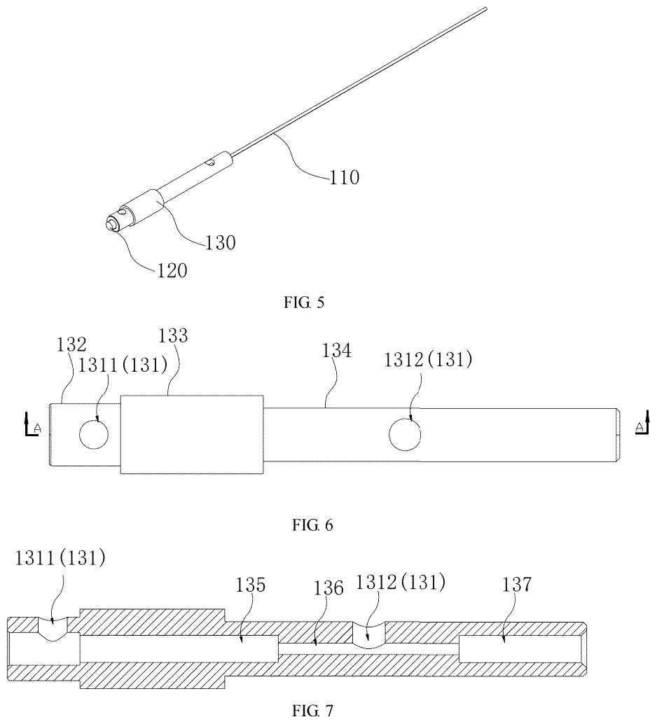

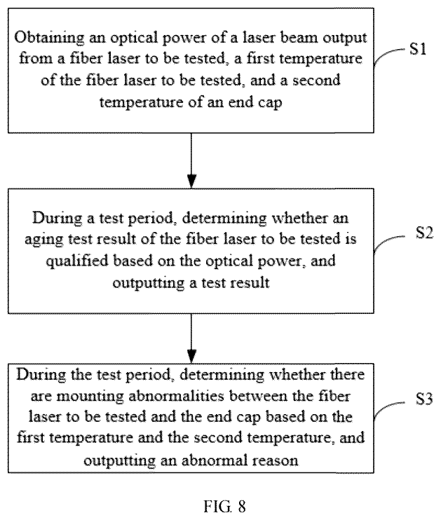

Referring to FIG. 3 to FIG. 7, FIG. 3 is a schematic diagram of a structure of an assembly of an output fiber and a fiber fixing tooling provided in an embodiment of the present application, FIG. 4 is a schematic diagram of a structure of a fiber fixing tooling provided in an embodiment of the present application, FIG. 5 is a schematic diagram of a structure of an output fiber provided in an embodiment of the present application, FIG. 6 is a top view of a metal housing of an output fiber provided in an embodiment of the present application, and FIG. 7 is a cross-sectional view of the metal housing taken along line A-A in FIG. 6.

The output fiber 100 includes a fiber body 110, an end cap 120, and a metal housing 130. The fiber body 110 includes a fiber core, a cladding, and a coating layer. The cladding is sleeved on the fiber core, and the coating layer is coated on the cladding. The fiber body 110 includes an optical input end and an optical output end. The optical input end is connected to a fiber laser to be tested. The fiber core of the optical output end is fused to the end cap 120. A fiber stripping opening is formed at a position, close to the end cap 120, of the fiber body 110. The fiber stripping opening is in a range of 10 millimeters from a fusion point between the fiber output end and the end cap. The end cap 120 is configured as a quartz end cap. A surface of the end cap 120 is coated with an anti-reflection film. An output end surface of the end cap 120 is coated with an anti-reflection film. Returning light enters the end cap 120 from the output end surface, and enters from an optically denser medium to an optically thinner medium in the end cap 120, which weakens energy of the returning light that continues to be transmitted forward, so that most of the returning light cannot reach the fiber body 110, thus greatly reducing damage of the returning light to the device itself. The metal housing 130 is sleeved on the end cap 120 and the fiber body 110 close to the end cap 120, and the fiber body 110 is connected to the end cap 120 through the metal housing 130. The end cap 120 and a segment, close to the optical output end, of the fiber body 110 are encapsulated in the metal housing 130. The end cap 120 is firmly connected to the fiber body 110 to avoid exposure of the fiber stripping opening. In addition, the metal housing 130 has an advantage of good thermal conductivity, which helps the fiber body 110 and the end cap 120 dissipate heat quickly, improving the performance and reliability of the output fiber. The metal housing 130 can be made of aluminum alloy metamaterials, and is simple in structure and low in production cost. As shown in FIG. 6 and FIG. 7, multiple glue dispensing holes 131 are formed in the metal housing 130, and the multiple glue dispensing holes 131 are arranged at intervals along an axial direction of the fiber body 110. The glue is injected into the glue dispensing holes 131, so that the metal housing 130 is glued with the fiber body 110 and the end cap 120, which is convenient for the assembly and disassembly of the metal housing 130 with the fiber body 110 and the end cap 120. The metal housing 130 can be reused, thereby reducing test costs. Referring to FIG. 6 and FIG. 7, the multiple glue dispensing holes 131 include a first glue dispensing hole 1311 and a second glue dispensing hole 1312. The first glue dispensing hole 1311 corresponds to the end cap 120, and the second glue dispensing hole 1312 corresponds to the fiber body 110. The glue is injected into the first glue dispensing hole 1311, so that the metal housing 130 is glued with the end cap 120. The glue is injected into the second glue dispensing hole 1312, so that the metal housing 130 is glued with the end cap 120. The glue is injected in segments, which facilitates glue dispensing operation, can avoid areas unsuitable for injecting glue, and ensures the performance of the output fiber. Referring to FIG. 7, the metal housing 130 includes a first cavity 135, a second cavity 136, and a third cavity 137 connected in sequence. The first cavity 135 is closer to the end cap 120 than the second cavity 136. A diameter of the second cavity 136 is smaller than a diameter of the first cavity 135, and smaller than a diameter of the third cavity 137. The second glue dispensing hole 1312 is formed on the metal housing 130 corresponding to the second cavity 136. The fiber stripping opening is located in the first cavity 135, and the second glue dispensing hole 1312 is located in the second cavity 136 to prevent the glue from entering the first cavity 135 and the third cavity 137 on two sides of the second cavity from the second cavity 136, so as to prevent the glue from covering the fiber stripping opening and ensure a light transmission performance of the output fiber. An aperture of the third cavity 137 is large, which is beneficial for the fiber body 110 to pass through the metal housing 130 and the assembly operation of the output fiber. Referring to FIG. 6, the metal housing 130 includes a first segment 132, a second segment 133, and a third segment 134 connected in sequence. The first segment 132 is sleeved on the end cap 120. The first segment 132, the second segment 133, and the third segment 134 are all in a shape of a cylinder. An outer diameter of the first segment 132 and an outer diameter of the third segment 134 are both smaller than an outer diameter of the second segment 133.

Referring to FIG. 3 and FIG. 4, the fiber fixing tooling 200 includes a base body 210, a first mounting slot 220, and a second mounting slot 230. The base body 210 is of a rectangular block structure. The base body 210 includes a first end 211, a second end 212, and a first side surface 213. The first end 211 is arranged opposite to the second end 212. The first mounting slot 220 is formed on the first side surface 213. The first mounting slot 220 extends from the first end 211 to the second end 212. The first mounting slot 220 includes a first side wall 221 and a second side wall 222. The first side wall 221 and the second side wall 222 are arranged opposite to each other and at intervals. The first side wall 221 and the second side wall 222 protrude from the first side surface. A size of the first mounting slot 220 is adapted to a size of the metal housing 130. A size of a gap between the first side wall 221 and the second side wall 222 is slightly smaller than a size of an outer wall of the metal housing 130. The output fiber 100 is mounted into the first mounting slot 220 from the gap between the first side wall 221 and the second side wall 222. Since a distance between the first side wall 221 and the second side wall 222 is slightly smaller than an outer wall diameter of the metal housing 130, the movement of the metal housing 130 within the first mounting slot 220 is limited, and the metal housing 130 is prevented from sliding out of the gap between the first side wall 221 and the second side wall 222. The end cap 120 extends from the first end 211. The second mounting slot 230 is formed on the first side surface 213, the second mounting slot 230 is in communication with the first mounting slot 220, and the fiber body 110 is mounted in the second mounting slot 230. A heat dissipation channel, a liquid cooling medium inlet, and a liquid cooling medium outlet are formed in the base body 210; and the liquid cooling medium inlet and the liquid cooling medium outlet are in communication with the heat dissipation channel. A liquid cooling medium can be water, and the heat dissipation channel in communication with a refrigerator through the liquid cooling medium inlet and the liquid cooling medium outlet to form a base body 210 with circulating water cooling in the heat dissipation channel to dissipate heat from the output fiber 100, so that the output fiber 100 is avoided from burning out due to heating, thus the output fiber 100 is protected, and the reliability of the output fiber 100 is improved. The first mounting slot 220 further includes a third side wall 223, and the third side wall 223 is arranged on the first end 211 and extends in a direction facing away from the second end 212. The third side wall 223 is configured for supporting a position, close to the end cap 120, of the output fiber 100. The end cap 120 is suspended outside the base body 210 to avoid interference between the end cap 120 and other components and protect the end cap 120. The base body 210, the first side wall 221, the second side wall 222, and the third side wall 223 are formed as an integrated structure made of metal materials. The integrated structure can be molded by mold injection or stamping, and the fiber fixing tooling is simple in processing technology. A wall thickness of an end, facing away from the first side surface 213, of the first side wall 221 is smaller than a wall thickness of an end, close to the first side surface 213, of the first side wall 221; and a wall thickness of an end, away from the first side surface 213, of the second side wall 222 is smaller than a wall thickness of an end, close to the first side surface 213, of the second side wall 222. A thickness of one end of the first side wall 221 is smaller than a thickness of another end of the first side wall 221; and a thickness of one end of the second side wall 222 is smaller than a thickness of another end of the second side wall 222. In mounting process of the output fiber 100, the first side wall 221 and the second side wall 222 are pushed apart by the metal housing 130 of the output fiber 100. The ends of the first side wall 221 and the second side wall 222 are thin and easy to deform, so that the output fiber 100 is avoided from being scratched while smoothly entering. After the output fiber 100 entered the first mounting slot 220, another ends of the first side wall 221 and the second side wall 222 is thick and difficult to deform, so that the output fiber 100 is prevented from slipping out due to deformation of the first side wall 221 and the second side wall 222, and stable mounting of the output fiber 100 is ensured. Taking a cross section in a direction perpendicular to a length direction of the first mounting slot 220, a cross section of the first mounting slot 220 is in a shape of letter “U”. Specifically, the first mounting slot 220 includes a first sub-slot 224 and a second sub-slot 225, the first sub-slot 224 is close to the first end 211, and the first side wall 221 and the second side wall 222 are located on the first sub-slot 224. The first sub-slot 224 and the second sub-slot 225 are arranged at intervals. A recessed area 214 is formed on the first side surface 213 of the base body 210 between the first sub-slot 224 and the second sub-slot 225. The first sub-slot 224 supports a part of one end, close to the end cap 120, of the metal housing 130, and the second sub-slot 225 supports a part of another end, closed to the end cap, of the metal housing 130. A middle part of the metal housing 130 is located in the recessed area 214. In test process of the fiber laser, an infrared thermometer can be configured for monitoring a temperature of the metal housing 130 from a position of the recessed area 214. The first sub-slot 224 mentioned above includes a first slot segment and a second slot segment. A size of the first slot segment is adapted to a size of the outer diameter of the second segment 133 of the metal housing 130. The first side wall 221 and the second side wall 222 extend upward from the first slot segment and protrude from the first side surface 213. A size of the second slot segment is adapted to the outer diameter of the third segment 134 of the metal housing 130. The first side wall 221 and the second side wall 222 act on a thickest position of the metal housing 130, resulting in a better and more stable clamping effect. Taking a cross section in a direction perpendicular to a length direction of the first mounting slot 220, and a cross section of the second mounting slot 230 is in a shape of letter “V”. As a variant, the cross section of the second mounting slot 230 can also be in a shape of a semi-circle. The fiber fixing tooling further includes a baffle 240, the baffle 240 is arranged on the first side surface 213, and the baffle 240 is close to the second end 212. The baffle 240 includes a groove 241, and the groove 241 is used for the output fiber 100 to extend therefrom. The groove 241 is in a shape of letter “V”, which is convenient for the output fiber 100 to enter and exit. The output fiber 100 is now restricted by the baffle 240 to avoid the output fiber 100 from sliding out of the second mounting slot 230, so that the output fiber 100 is ensured to be located on the same axis. A mounting hole 215 is formed on the substrate 210. The base body is connected to a water-cooling plate or a workbench through the mounting hole 215.

The cooling assembly 300 described above includes a water-cooling plate. The fiber laser to be tested is mounted on the water-cooling plate. A heat generated during testing of the fiber laser to be tested is taken away by circulating cooling water in the water-cooling plate, so that the fiber laser to be tested is avoided being burned out due to heat, and the reliability of the fiber laser to be tested is ensured.

The temperature detecting device described above includes an infrared thermometer, and a temperature sensor arranged on the water-cooling plate. The temperature sensor is configured for detecting a first temperature of the housing of the fiber laser to be tested in real time, and the infrared thermometer is configured for detecting a second temperature of the end cap of the output fiber in real time.

The power detecting device described above is configured as an integrating sphere. A light input end of the integrating sphere is opposite to a light output end of the output fiber 100. A light intensity of a laser beam emitted from the output fiber 100 is detected by the integrating sphere, and an optical power is calculated based on the light intensity.

Referring to FIG. 2, the controller is connected to the power detecting device and the temperature detecting device described above respectively. The controller is configured for receiving the optical power, the first temperature, and the second temperature. During a testing period, whether an aging test result of the fiber laser to be tested is qualified is determined based on the optical power, and a test result is output. During a testing period, based on the first temperature and the second temperature, whether there is a mounting abnormality among the fiber laser to be tested, the cooling assembly, and the end cap is determined, and an abnormal result is output.

It can be understood that during a laser aging test, the laser beam emitted from the fiber laser to be tested is injected into the integrating sphere through the output fiber, and the optical power of the fiber laser to be tested is detected by the integrating sphere. The temperature detecting device detects the first temperature of the housing of the fiber laser to be tested and the second temperature of the end cap of the output fiber in real time, so that a poor assembly between the fiber laser to be tested and the cooling assembly is avoided, or an abnormity of the end cap of the output fiber is avoided, and the abnormal result is output, which is convenient for operators to troubleshoot, avoids affecting the aging test result, and ensures the accuracy of the test result.

In some embodiments, a power threshold, a first temperature threshold and a second temperature threshold are set in the controller. The controller is configured for comparing the optical power with the power threshold. During the testing period, in case that the optical power exceeds the power threshold, the aging test result of the fiber laser to be tested is determined to be unqualified. Comparing the first temperature with the first temperature threshold, in case that the first temperature exceeds the first temperature threshold, the assembly between the fiber laser and the cooling assembly to be tested is determined to be poor. Comparing the second temperature with the second temperature threshold, in case that the second temperature exceeds the second temperature threshold, the end cap is determined to be abnormal.

It can be understood that during the testing period, the first temperature is compared with the first temperature threshold, the second temperature is compared with the second temperature threshold, and the optical power is compared with the power threshold. In case that the optical power is greater than the power threshold, it is indicated that the aging test result of the laser to be tested is unqualified. In case that the first temperature is greater than the first temperature threshold, it is indicated that the assembly between the fiber laser to be tested and the cooling assembly is poor. In case that the second temperature is greater than the second temperature threshold, it is indicated that the end cap of the output fiber 100 is abnormal. The problems with the fiber laser to be tested itself are eliminated based on the first temperature and the second temperature to ensure the accuracy of the test result of the fiber laser to be tested.

Based on the implementations described above, once determining that the assembly between the fiber laser to be tested and the cooling assembly is poor, the controller is further configured for outputting a prompt information for reassembling the fiber laser to be tested with the cooling assembly.

Based on the implementations described above, after determining the end cap is abnormal, the controller is further configured for outputting a prompt information for replacing or wiping the end cap.

It can be understood that the controller may be connected to a display screen. in case that the first temperature is greater than the first temperature threshold, the controller determines that the assembly between the fiber laser to be tested and the cooling assembly is poor, and outputs the prompt information for reassembling the fiber laser to be tested with the water cooling assembly. In case that the second temperature is greater than the second temperature threshold, the controller determines that the end cap of the output fiber is abnormal, and outputs the prompt information for replacing or wiping the end cap. Operators can receive the prompt information directly from the display screen, which facilitates for uses to operate.

After the users reassemble the fiber laser to be tested with the water cooling assembly, or, replace or wipe the end cap, the aging test of the fiber laser to be tested is continued until before or after the fiber laser to be tested is reassembled with the water cooling assembly, or, a test time before or after replacing or wiping the end cap reaches a test time period, one aging test of the fiber laser to be tested is completed. It can be understood that the reassembly of the fiber laser to be tested with the water cooling assembly, or the replacement or wiping of the end cap is considered as an interruption of the aging test and would not affect an entire test duration.

Based on the implementations described above, in order to improve the accuracy of the aging test result of the fiber laser to be tested, the controller is further configured for generating a power-time curve. A curvature threshold is preset. In case that the optical power does not exceed the power threshold, a curvature of the power-time curve is compared with the curvature threshold to determine whether the aging test result of the fiber laser to be tested is qualified.

It can be understood that during a fiber laser aging test, whether the test result of the fiber laser to be tested is qualified can be determined only based on the optical power. For example, in case that the optical power exceeds the optical power threshold, the aging test result of the fiber laser to be tested is determined to be unqualified. In case that the optical power does not exceed the optical power threshold, the aging test result of the fiber laser to be tested is determined to be qualified.

The optical power can be also combined with a change of the optical power to determine whether the test result of the fiber laser to be tested is qualified. For example, in case that the optical power exceeds the optical power threshold, the aging test result of the fiber laser to be tested is determined to be unqualified. In case that the optical power does not exceed the optical power threshold, the curvature of the power-time curve is compared with the curvature threshold. In case that the curvature is greater than the curvature threshold, it is indicated that change in the power of the fiber laser to be tested is great, performance of the fiber laser to be tested is unstable, and the aging test result of the fiber laser to be tested is unqualified. In case that the curvature is less than the curvature threshold, change of the power of the fiber laser to be tested is little, the performance of the fiber laser to be tested is stable, and the aging test result of the fiber laser to be tested is qualified. The aging condition of the fiber laser to be tested is comprehensively determined from two aspects of power and curvature, and the test result are improved.

Based on the implementations described above, the output fiber can be a single-clad fiber or a double-clad fiber. In case that the output fiber is a double-clad fiber, the temperature detecting device is further configured for detecting a third temperature of a cladding of the output fiber. A third temperature threshold is set in the controller, and the controller is configured for receiving the third temperature. During a testing period, the third temperature is compared with the third temperature threshold to determine whether the aging test result of the fiber laser to be tested is qualified, and the test result is output. In case that the third temperature is greater than the third temperature threshold, the aging test result of the fiber laser to be tested is determined to be unqualified. In case that the third temperature is less than the third temperature threshold, the aging test result of the fiber laser to be tested is determined to be qualified.

It can be understood that when determining whether the aging test result of the fiber laser to be tested is qualified based on the optical power and the third temperature, in case that the optical power is less than the power threshold and the third temperature is less than the third temperature threshold, the aging test result of the fiber laser to be tested is determined to be qualified, otherwise, the aging test result of the output fiber laser to be tested is unqualified. When determining whether the aging test result of the fiber laser to be tested is qualified based on the optical power, the curvature of the power-time curve and the third temperature, in case that the optical power is less than the power threshold, the curvature of the power-time curve is less than the curvature threshold and the third temperature is less than the third temperature threshold, the aging test result of the fiber laser to be tested is determined to be qualified, and in other cases, the aging test result is unqualified. Multiple parameters are set to detect the fiber laser to be tested from multiple aspects, and test results are accurate.

In addition, abnormalities in the optical power and the third temperature can further indicate possible problems with the fiber laser to be tested. An abnormal optical power indicates that a problem with a chip of the laser to be tested, and an abnormal third temperature can indicate that a problem with an encapsulation of the fiber laser to be tested, which can guide a repair of the fiber laser to be tested and facilitate users to operate.

As shown in FIG. 8, FIG. 8 is a flow diagram of a fiber laser testing method provided in an embodiment of the present application.

Embodiments of the present application further provide a fiber laser testing method, applied to the above fiber laser testing system of any of the embodiments described above. The method includes following steps:
S1, obtaining an optical power of a laser beam output from a fiber laser to be tested, a first temperature of the fiber laser to be tested, and a second temperature of an end cap;
S2, during a testing period, determining whether an aging test result of the fiber laser to be tested is qualified based on the optical power, and outputting a test result; and
S3, during the testing period, determining whether there are abnormalities in the fiber laser to be tested and the end cap based on the first temperature and the second temperature, and outputting an abnormal reason.

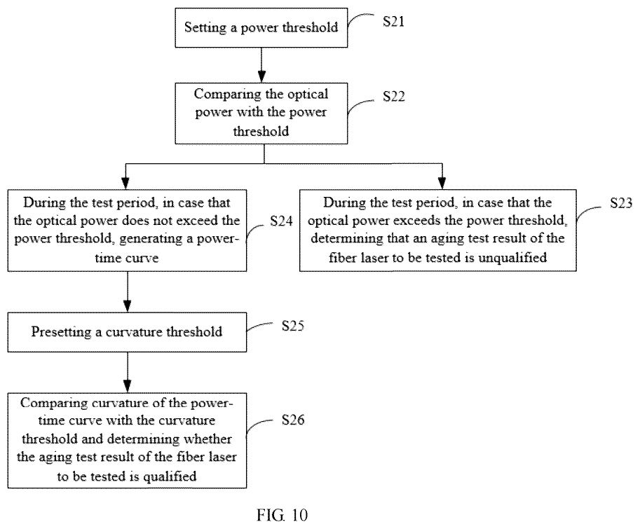

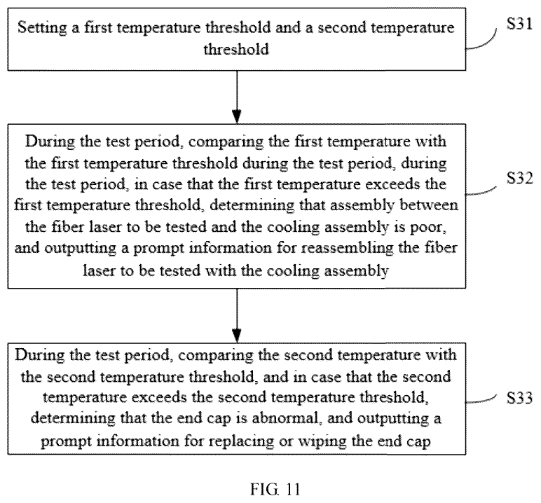

As shown in FIG. 10, FIG. 10 is a flow diagram of a fiber laser testing method provided in an embodiment of the present application.

In some embodiments, the step S2 described above includes following specific steps:
S21, setting a power threshold;
S22, comparing the optical power with the power threshold; and
S23, during the testing period, in case that the optical power exceeds the power threshold, determining that the aging test result of the fiber laser to be tested is unqualified.

In some embodiments, as shown in FIG. 10, the step S2 described above further includes following specific steps:
S24, during the testing period, in case that the optical power does not exceed the power threshold, generating a power-time curve;
S25, presetting a curvature threshold; and
S26, in case that the optical power does not exceed the power threshold, comparing a curvature of the power-time curve with the curvature threshold, and determining whether the aging test result of the fiber laser to be tested is qualified.

As shown in FIG. 11, FIG. 11 is a flow diagram of a fiber laser testing method provided in an embodiment of the present application.

In some embodiments, the step S3 described above includes following specific steps:
S31, setting a first temperature threshold and a second temperature threshold;
S32, during the testing period, comparing the first temperature with the first temperature threshold, in case that the first temperature exceeds the first temperature threshold during the testing period, determining that assembly between the fiber laser to be tested and the cooling assembly is poor, and outputting a prompt information for reassembling the fiber laser to be tested with the cooling assembly; and
S33, during the testing period, comparing the second temperature with the second temperature threshold, and in case that the second temperature exceeds the second temperature threshold, determining that the end cap is abnormal, and outputting a prompt information for replacing or wiping the end cap.

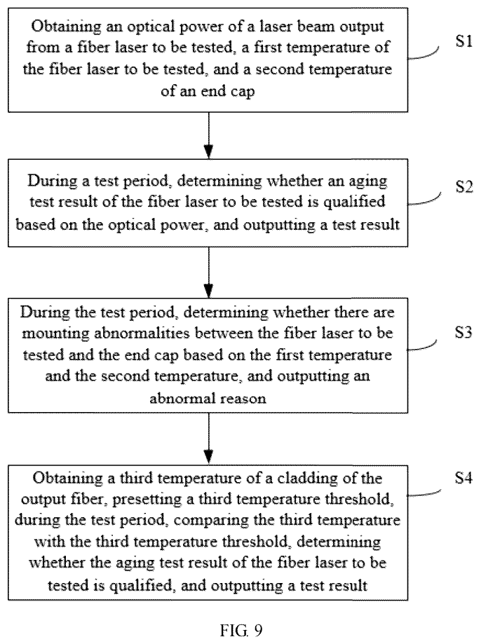

As shown in FIG. 9, FIG. 9 is a flow diagram of a fiber laser testing method provided in an embodiment of the present application.

In some embodiments, in case that the output fiber is a double-clad fiber, following steps are further included:
S4, obtaining a third temperature of a cladding of the output fiber, presetting a third temperature threshold, during the testing period, comparing the third temperature with the third temperature threshold, determining whether the aging test result of the fiber laser to be tested is qualified, and outputting a test result.

It can be understood that in case that the third temperature exceeds the third temperature threshold during the testing period, the aging test result of the fiber laser to be tested are determined to be unqualified.

In the embodiments described above, a description of each embodiment has its own emphasis, and a part that is not detailed in one embodiment can be seen in a relevant description of any of other embodiments.

In the description of the present application, the terms “first” and “second” are used only for descriptive purposes and cannot be understood as indicating or implying relative importance or implicitly indicating the number of technical features indicated. Therefore, the features defined as “first” and “second” can explicitly or implicitly include one or more features.

The fiber laser testing system and the fiber laser testing method provided by the embodiments of the present application are introduced in detail. In this paper, the principle and implementation methods of the present application are expounded by using specific examples. The above embodiments are only used to help understand the technical proposal and the core idea of the present application. At the same time, for those skilled in this field, according to the nature of the present application, there will be changes in the specific implementation methods and application scope. In summary, the content of this specification should not be understood as a limitation on the present application.

1. A fiber laser testing system, comprising:
an output fiber, comprising a fiber body and a metal housing, one end of the fiber body being connected to a fiber laser to be tested, another end of the fiber body being fused to an end cap, and the metal housing being sleeved on the end cap and the fiber body;
a fiber fixing tooling, configured for fixing the output fiber;
a cooling assembly, configured for cooling the fiber laser to be tested and the end cap;
a power test device, configured for detecting an optical power of a laser beam emitted from the output fiber in real time;
a temperature test device, configured for detecting a first temperature of the fiber laser to be tested and a second temperature of the end cap in real time; and
a controller, connected to the power test device and the temperature test device respectively, the controller being configured for:
receiving the optical power, the first temperature, and the second temperature;
during a testing period, determining whether an aging test result of the fiber laser to be tested is qualified based on the optical power, and outputting a test result; and
during a testing period, determining whether there are mounting abnormalities among the fiber laser to be tested, the cooling assembly, and the end cap based on the first temperature and the second temperature, and outputting an abnormal result.

2. The fiber laser testing system of claim 1, further comprising:
a power threshold, a first temperature threshold, and a second temperature threshold are set in the controller, and the controller is configured for:
comparing the optical power with the power threshold, during the testing period, in case that the optical power exceeds the power threshold, determining the aging test result of the fiber laser to be tested is unqualified;
comparing the first temperature with the first temperature threshold, in case that the first temperature exceeds the first temperature threshold, determining assembly between the fiber laser to be tested and the cooling assembly is poor; and
comparing the second temperature with the second temperature threshold, in case that the second temperature exceeds the second temperature threshold, determining the end cap is abnormal.

3. The fiber laser testing system of claim 2, wherein once determining that the assembly between the fiber laser to be tested and the cooling assembly is poor, the controller is further configured for:
outputting a prompt information for reassembling the fiber laser to be tested with the cooling assembly.

4. The fiber laser testing system of claim 2, wherein once determining that the end cap is abnormal, the controller is further configured for:
outputting a prompt information for replacing or wiping the end cap.

5. The fiber laser testing system of claim 2, wherein the controller is further configured for:
generating a power-time curve;
presetting a curvature threshold; and
in case that the optical power does not exceed the power threshold, comparing a curvature of the power-time curve with the curvature threshold, and determining whether the aging test result of the fiber laser to be tested is qualified.

6. The fiber laser testing system of claim 1, wherein in case that the output fiber is a double-clad fiber, the temperature test device is further configured for detecting a third temperature of a cladding of the output fiber, a third temperature threshold is set in the controller, and the controller is configured for:
receiving the third temperature; and
during a testing period, comparing the third temperature with the third temperature threshold, determining whether the aging test result of the fiber laser to be tested is qualified, and outputting a test result.

7. A fiber laser testing system, configured for performance testing of a fiber laser during a development stage or a production stage, comprising:
an output fiber, comprising a fiber body and a metal housing, one end of the fiber body being connected to a fiber laser to be tested, another end of the fiber body being fused to an end cap, and the metal housing being sleeved on the end cap and the fiber body;
a fiber fixing tooling, configured for fixing the output fiber, the fiber fixing tooling comprises a base body, a first mounting slot, and a second mounting slot, the base body comprising a first end, a second end, and a first side surface, the first mounting slot extending from the first end to the second end, the second mounting slot being formed on the first side surface, the second mounting slot being in communication with the first mounting slot, the fiber body being mounted in the second mounting slot, the metal housing being mounted in the first mounting slot, and the end cap extending out of the first end;
a cooling assembly, configured for cooling the fiber laser to be tested and the end cap, the cooling assembly comprising a water-cooling plate, and the fiber laser to be tested and the base body being mounted on the water-cooling plate;
a power test device, configured for detecting an optical power of a laser beam emitted from the output fiber in real time;
a temperature test device, configured for detecting a first temperature of the fiber laser to be tested and a second temperature of the end cap in real time; and
a controller, connected to the power test device and the temperature test device respectively, the controller being configured for:
receiving the optical power, the first temperature, and the second temperature;
during a testing period, determining whether an aging test result of the fiber laser to be tested is qualified based on the optical power, and outputting a test result; and
during a testing period, determining whether there are mounting abnormalities among the fiber laser to be tested, the cooling assembly, and the end cap based on the first temperature and the second temperature, and outputting an abnormal result.

8. A fiber laser testing method, applied to a fiber laser testing system, the fiber laser testing system comprising:
an output fiber, comprising a fiber body and a metal housing, one end of the fiber body being connected to a fiber laser to be tested, another end of the fiber body being fused to an end cap, and the metal housing being sleeved on the end cap and the fiber body;
a fiber fixing tooling, configured for fixing the output fiber;
a cooling assembly, configured for cooling the fiber laser to be tested and the end cap;
a power test device, configured for detecting an optical power of a laser beam emitted from the output fiber in real time;
a temperature test device, configured for detecting a first temperature of the fiber laser to be tested and a second temperature of the end cap in real time; and
a controller, connected to the power test device and the temperature test device respectively, the controller being configured for:
receiving the optical power, the first temperature, and the second temperature;
during a testing period, determining whether an aging test result of the fiber laser to be tested is qualified based on the optical power, and outputting a test result; and
during a testing period, determining whether there are mounting abnormalities among the fiber laser to be tested, the cooling assembly, and the end cap based on the first temperature and the second temperature, and outputting an abnormal result;
and the fiber laser testing method comprising following steps:
obtaining an optical power of a laser beam output from a fiber laser to be tested, a first temperature of the fiber laser to be tested, and a second temperature of an end cap;
during a testing period, determining whether an aging test result of the fiber laser to be tested is qualified based on the optical power, and outputting a test result; and
during a testing period, determining whether there are mounting abnormalities between the fiber laser to be tested and the end cap based on the first temperature and the second temperature, and outputting an abnormal reason.

9. The fiber laser testing method of claim 8, wherein determining whether there are mounting abnormalities between the fiber laser to be tested and the end cap based on the first temperature and the second temperature, and outputting the abnormal reason comprises following steps:
setting a first temperature threshold and a second temperature threshold;
during the testing period, comparing the first temperature with the first temperature threshold, in case that the first temperature exceeds the first temperature threshold during the testing period, determining that assembly between the fiber laser to be tested and the cooling assembly is poor, and outputting a prompt information for reassembling the fiber laser to be tested with the cooling assembly; and
during the testing period, comparing the second temperature with the second temperature threshold, and in case that the second temperature exceeds the second temperature threshold, determining that the end cap is abnormal, and outputting a prompt information for replacing or wiping the end cap.

10. The fiber laser testing method of claim 8, wherein the determining whether the aging test result of the fiber laser to be tested is qualified based on the optical power, and outputting the test result comprises following steps:
setting a power threshold; and
comparing the optical power with the power threshold, during the testing period, in case that the optical power exceeds the power threshold, determining that the aging test result of the fiber laser to be tested is unqualified.

11. The fiber laser testing method of claim 10, wherein comparing the optical power with the power threshold, during the testing period, in case that the optical power exceeds the power threshold further comprises following steps:
generating a power-time curve;
presetting a curvature threshold; and
comparing curvature of the power-time curve with the curvature threshold, and determining whether the aging test result of the fiber laser to be tested is qualified.

12. The fiber laser testing method of claim 8, wherein in case that the output fiber is a double-clad fiber, further comprising following steps:
obtaining a third temperature of a cladding of the output fiber;
presetting a third temperature threshold; and
during the testing period, comparing the third temperature with the third temperature threshold, determining whether the aging test result of the fiber laser to be tested is qualified, and outputting a test result.
